(19) United States
(12) Patent Application Publication
(10) Pub. No.: US 2016/0044304 A1
(43) Pub. Date: Feb. 11, 2016

(54) IMAGE DISPLAYING METHOD AND APPARATUS FOR MULTI-VIEW STEREOSCOPIC DISPLAY DEVICE

(71) Applicant: Shenzhen China Star Optoelectronics Technology Co. Ltd., Shenzhen, Guangdong (CN)

(72) Inventors: Qiaosheng LIAO, Shenzhen, Guangdong (CN); Chihming YANG, Shenzhen, Guangdong (CN)

(73) Assignee: Shenzhen China Star Optoelectronics Technology Co. Ltd., Shenzhen, Guangdong (CN)

(21) Appl. No.: 14/379,387

(22) PCT Filed: Aug. 8, 2014
(86) PCT No.: PCT/CN2014/083959

§ 371 Date: Aug. 18, 2014

(30) Foreign Application Priority Data
Aug. 5, 2014 (CN) 201410382768X

(51) Int. Cl. H04N 13/04

(52) U.S. Cl. CPC H04N 13/0445; H04N 13/0497; H04N 13/0468; H04N 13/0486

(57) ABSTRACT

An image displaying method and an image displaying apparatus for a multi-view stereoscopic display device are provided. The method includes: determining an inversion region, the inversion region being a location wherein viewpoints respectively corresponding to left and right eyes of the viewer are in neighboring viewing zones; and replacing at least one of a viewpoint image of the viewpoint in the inversion region corresponding to the left eye and a viewpoint image of the viewpoint in the inversion region corresponding to the right eye to be a viewpoint image of other viewpoint, to thereby reduce a parallax reversal degree of the two viewpoint images. By the above method, a content difference between the viewpoint images of the viewpoints respectively corresponding to the left and right eyes is reduced and the degree of comfort of viewing to the viewer is improved consequently.

### TECHNICAL FIELD

The present invention relates to the field of stereoscopic display technology, and particularly to an image displaying method and an image displaying apparatus for multi-view stereoscopic display device.

### DESCRIPTION OF RELATED ART

Recently, with the stereoscopic display technology being widely used in various application fields, the stereoscopic display technology is gaining more and more attention. A multi-view display technology is an important stereoscopic display technology. The multi-view display technology would form multiple (i.e., more than one) repeating viewing zones in a viewing space. Each of the viewing zones includes multiple viewpoints and thereby provides multiple viewpoints for the viewing space, so that the viewer can enjoy a certain degree of freedom of viewing. In a large-viewing-angle multi-view display architecture, left eye and right eye of the viewer would leap over multiple viewpoints of viewing zone located therebetween, for example, the left eye of the viewer is at a first viewpoint, and the right eye of the viewer may be at the seventh viewpoint. Therefore, an image can uniformly transition in the process of the viewer is moving and thus the feeling of transition is not obvious. However, if the viewer is in an inversion region, a reversal degree of viewpoint images corresponding to viewpoints obtained by the left eye and the right eye respectively would sharply increase, so that a content difference between the images respectively obtained by the left eye and the right eye is large and even contents of the images corresponding to the viewpoints can not constitute a 3D image, which leads to a strong and sudden visual reversal stimulation to the viewer and thereby greatly reduces the degree of comfort of viewing to the viewer.

### SUMMARY

A technical problem primarily solved by the present invention is to provide an image displaying method and an image displaying apparatus for multi-view stereoscopic display device, so as to solve the problems of the content difference between the left eye and right eye images in the inversion region being large and thereby the degree of comfort of viewing to the viewer being reduced.

In order to solve the above technical problem, a technical solution proposed by the present invention is to provide an image displaying method for a multi-view stereoscopic display device. The multi-view stereoscopic display device has multiple (i.e., more than one) viewing zones periodically arranged along a horizontal direction. Each viewing zone includes multiple viewpoints. Viewpoint images of neighboring viewpoints in each viewing zone have a predetermined parallax therebetween. The image displaying method includes: determining an inversion region, the inversion region being a location of a viewer where a viewpoint corresponding to left eye of the viewer and a viewpoint corresponding to right eye of the viewer respectively are in neighboring ones of the multiple viewing zones; obtaining a location of the viewer; judging the location of the viewer whether is in the inversion region; and when the location of the viewer is judged to be in the inversion region, replacing a viewpoint image of the viewpoint in the inversion region corresponding to the left eye of the viewer to be a viewpoint image of other viewpoint in a same viewing zone farther away from the viewpoint corresponding to the right eye of the viewer, or replacing a viewpoint image of the viewpoint in the inversion region corresponding to the right eye of the viewer to be a viewpoint image of other viewpoint in a same viewing zone farther away from the viewpoint corresponding to the left eye of the viewer, so as to reduce a parallax reversal degree of the two viewpoint images.

In an exemplary embodiment, the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, and K is a number of viewpoint in an interval between the left eye and right eye of the viewer.

In an exemplary embodiment, the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer, and b is a positive integer no greater than

$$\frac{N - a}{K - 1} .$$

In order to solve the above technical problem, another technical solution proposed by the present invention is to provide an image displaying method for a multi-view stereoscopic display device. The multi-view stereoscopic display device has multiple (i.e., more than one) viewing zones periodically arranged along a horizontal direction. Each viewing zone includes multiple viewpoints. Viewpoint images of neighboring viewpoints in each viewing zone have a predetermined parallax therebetween. The image displaying method includes: determining an inversion region, the inversion region being a location of a viewer where a viewpoint corresponding to left eye of the viewer and a viewpoint corresponding to right eye of the viewer respectively are in neighboring ones of the viewing zones; and replacing at least one of a viewpoint image of the viewpoint in the inversion region corresponding to the left eye of the viewer and a viewpoint image of the viewpoint in the inversion region corresponding to the right eye of the viewer to be a viewpoint image of other viewpoint, to thereby reduce a parallax reversal degree of the viewpoint images.

In an exemplary embodiment, before the step of replacing, further includes: obtaining a location of the viewer; judging the location of the viewer whether is in the inversion region, and when the location of the viewer is judged to be in the inversion region, performing the step of replacing.

In an exemplary embodiment, the step of replacing includes: replacing the viewpoint image of the viewpoint in the inversion region corresponding to the left eye of the viewer to be a viewpoint image of other viewpoint in a same viewing zone farther away from the viewpoint corresponding to the right eye of the viewer, or replacing the viewpoint image of the viewpoint in the inversion region corresponding to the right eye of the viewer to be a viewpoint image of other viewpoint in a same viewing zone farther away from the viewpoint corresponding to the left eye of the viewer.

In an exemplary embodiment, the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, and K is a number of viewpoint in an interval between the left eye and the right eye of the viewer.

In an exemplary embodiment, the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer, and b is a positive integer no greater than

$$\frac{N - a}{K - 1} .$$

In order to solve the above technical problem, still another technical solution proposed by the present invention is to provide an image displaying apparatus for a multi-view stereoscopic display device. The multi-view stereoscopic display device having multiple viewing zones periodically arranged along a horizontal direction. Each viewing zone includes multiple viewpoints, and viewpoint images of neighboring viewpoints in each viewing zone have a predetermined parallax therebetween. The image displaying apparatus includes: a determining module, configured (i.e., structured and arranged) to determine an inversion region, the inversion region being a location of viewer where a viewpoint corresponding to left eye of a viewer and a viewpoint corresponding to right eye of the viewer respectively are in neighboring ones of the viewing zones; and a processing module, configured to replace at least one of a viewpoint image of the viewpoint in the inversion region corresponding to the left eye of the viewer and a viewpoint image of the viewpoint in the inversion region corresponding to the right eye of the viewer to be a viewpoint image of other viewpoint, to thereby reduce a reversal degree of the viewpoint images.

In one exemplary embodiment, the processing module includes: an obtaining unit configured to obtain a location of the viewer; a judging unit configured to judge the location of the viewer whether is in the inversion region; and a replacing unit configured to replace at least one of the viewpoint image of the viewpoint in the inversion region corresponding to the left eye of the viewer and the viewpoint image of the viewpoint in the inversion region corresponding to the right eye of the viewer to be the viewpoint image of the other viewpoint when the judging unit judges that the location of the viewer is in the inversion region.

In an exemplary embodiment, the replacing unit is configured to replace the viewpoint image of the viewpoint in the inversion region corresponding to the left eye of the viewer to be a viewpoint image of other viewpoint in a same viewing zone farther away from the viewpoint corresponding to the right eye of the viewer, or replace the viewpoint image of the viewpoint in the inversion region corresponding to the right eye of the viewer to be a viewpoint image of other viewpoint in a same viewing zone farther away from the viewpoint corresponding to the left eye of the viewer.

In an exemplary embodiment, the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, and K is a number of viewpoint in an interval between the left eye and right eye of the viewer.

In an exemplary embodiment, the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer, and b is a positive integer no greater than

$$\frac{N - a}{K - 1} .$$

Beneficial effects can be achieved by the present invention are that: different from the prior art, the present invention replaces at least one of the viewpoint image of the viewpoint in the inversion region corresponding to the left eye of the viewer and the viewpoint image of the viewpoint in the inversion region corresponding to the right eye of the viewer to be a viewpoint image of other viewpoint to thereby reduce a parallax reversal degree of the two viewpoint images, so that a content difference between the viewpoint images of the viewpoints respectively corresponding to the left and right eyes is reduced and the degree of comfort of viewing to the viewer is improved consequently.

### BRIEF DESCRIPTION OF THE DRAWINGS

FIG. 1 is a schematic structural view of an image displaying apparatus for a multi-view stereoscopic display device according to an exemplary embodiment of the present invention.

FIG. 2 is a schematic view of a distribution of viewing zones of the image display apparatus for a multi-view stereoscopic display device in FIG. 1.

FIG. 3 is a schematic principle diagram of the image displaying apparatus for a multi-view stereoscopic display device in FIG. 1.

FIG. 4 is a schematic view of viewpoint reversal in an inversion region of FIG. 3 before viewpoint(s) being replaced.

FIG. 5 is a schematic view of viewpoint reversal in the inversion region of FIG. 3 after viewpoint(s) being replaced.

FIG. 6 is a flowchart of an image displaying method for a multi-view stereoscopic display device according to an exemplary embodiment of the present invention.

### DETAILED DESCRIPTION OF EMBODIMENTS

Referring to FIG. 1, which is a schematic structural view of an image displaying apparatus for a multi-view stereoscopic display device according to an exemplary embodiment. It is noted that, the multi-view stereoscopic display device has multiple (i.e., more than one) viewing zones periodically arranged along a horizontal direction. Each of the viewing zones includes multiple viewpoints, and viewpoint images of neighboring viewpoints in each viewing zone have a predetermined parallax. As shown in FIG. 1, the multi-view stereoscopic display device 10 according to the exemplary embodiment of the present invention includes a determining module 11 and a processing module 12. It is understood that, in an exemplary embodiment, the determining module 11 and processing module 12 may be software modules stored in a memory and executable by one or more processors of the multi-view stereoscopic display device 10, but not to limit the present invention.

The determining module 11 is configured (i.e., structured and arranged) to determine an inversion region. The inversion region is a location where a viewpoint corresponding to left eye and another viewpoint corresponding to right eye of a viewer respectively are in neighboring viewing zones.

Each of the viewing zones is sequentially numbered from left to right. Viewpoints respectively corresponding to the left eye and right eye of the viewer are across multiple viewpoints (i.e., spaced by multiple viewpoints). In particular, for example, the viewpoints respectively corresponding to the left eye and right eyes are across K viewpoints. When the viewpoint corresponding to the left eye is the viewpoint 1, the viewpoint corresponding to the right eye is viewpoint (K+1); when the viewpoint corresponding to the left eye is the viewpoint 2, the viewpoint corresponding to the right eye is viewpoint (K+2); and so on. It is understood that, K is a positive integer smaller than the total number of viewpoint in the viewing zone.

Since the viewpoints respectively corresponding to the left eye and right eye of the viewer are across multiple viewpoints, in some particular location, the viewpoints respectively corresponding to the left eye and right eye would be in different viewing zones, i.e., in neighboring viewing zones. In the exemplary embodiment, a location where a viewpoint corresponding to the left eye and another viewpoint corresponding to the right eye respectively are in neighboring viewing zones is defined as an inversion region, and a location where a viewpoint corresponding to the left eye and another viewpoint corresponding to the right eye are in a same viewing zone is defined as a normal region.

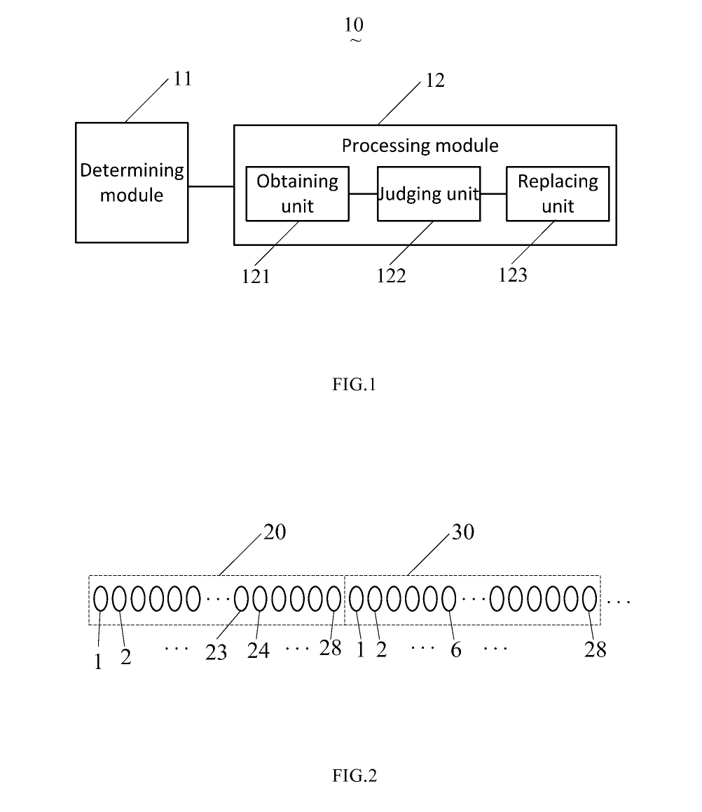

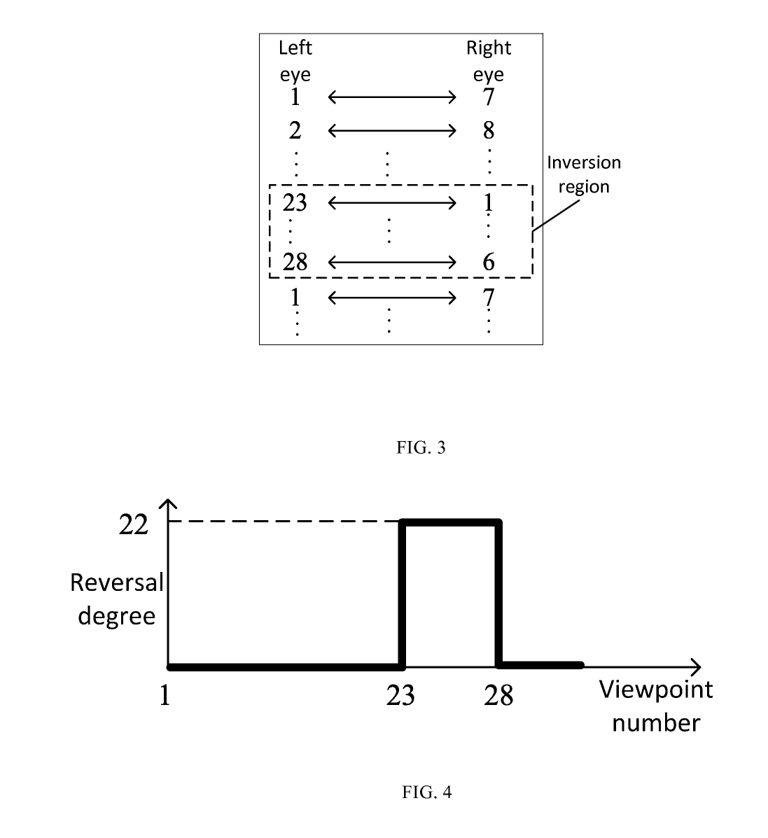

Referring to FIGS. 2 and 3 together, in the illustrated embodiment, the total number of viewpoint in each viewing zone is 28, and the viewpoints respectively corresponding to the left eye and the right eye are across 6 viewpoints, i.e., K is 6. As shown in FIGS. 2 and 3, the viewpoints in each viewing zones are sequentially numbered from left to right to be 1-28, and the viewing zone 20 and the viewing zone 30 are neighboring with each other. When the viewpoint corresponding to the left eye is the viewpoint 1, the viewpoint corresponding to the right eye is the viewpoint 7; when the viewpoint corresponding to the left eye is the viewpoint 2, the viewpoint corresponding to the right eye is the viewpoint 8; and so on; when the viewpoint corresponding to the left eye is the viewpoint 23, the viewpoint corresponding to the right eye is the viewpoint 1 in the neighboring viewing zone, and where the viewer is located belongs to the inversion region. Since when the viewpoint corresponding to the left eye is any of the viewpoints 23 to 28, the viewpoint corresponding to the right eye is corresponding one of the viewpoints 1 to 6 in the neighboring viewing zone and therefore the location of the viewer corresponding to from the viewpoint 23 in the viewing zone 20 to the viewpoint 6 in the viewing zone 30 is the inversion region. The viewpoint 23 in the viewing zone 20 and the viewpoint 6 in the viewing zone 30 are edge viewpoints of the inversion region.

A viewpoint image of a viewpoint of the inversion region corresponding to the left eye and another viewpoint image of another viewpoint of the inversion region have a reversal degree therebetween. The larger the reversal degree, the worse the stereo image effect formed by the viewpoint images of the viewpoints respectively corresponding to the left eye and right eye.

In the illustrated embodiment, the processing module 12 is configured to replace at least one of viewpoint images of the viewpoints in the inversion region respectively corresponding to the left eye and right eye of the viewer by a viewpoint image of other viewpoint to thereby reduce the reversal degree of the viewpoint images.

Accordingly, in the illustrated embodiment, by replacing at least one of viewpoint images of the viewpoints in the inversion region respectively corresponding to the left eye and right eye of the viewer by a viewpoint image of other viewpoint, the reversal degree between the viewpoint image of the viewpoint in the inversion region corresponding to the left eye and the viewpoint of the viewpoint in the inversion region corresponding to the right eye is reduced, so that a content difference between the viewpoint images of the viewpoints respectively corresponding to the left eye and right eye is reduced and a degree of comfort of viewing to the viewer is improved consequently.

Optionally, the processing module 12 includes an obtaining unit 121, a judging unit 122 and a replacing unit 123.

The obtaining unit 121 is configured to obtaining a location of a viewer. The judging unit 122 is configured to judge the location of the viewer whether is in an inversion region. The replacing unit 123 is configured to replace at least one of viewpoint images of viewpoints in the inversion region respectively corresponding to left eye and right eye of the viewer by a viewpoint image of other viewpoint when the judging unit 122 judges that the location of the viewer is in the inversion region.

In other embodiment, in order to reduce the cost, the obtaining unit 121 and the judging unit 122 may be omitted. Specifically, the judging of the location of the viewer whether being in the inversion region is omitted, and in the manufacturing of the multi-view stereoscopic display device 10, the inversion region and the normal region are directly determined according to a distribution of viewpoints in viewing zones, and viewpoint images of the viewpoints in the inversion region then are directly performed with the replacing operation.

More specifically, the replacing unit 123 is configured to replace the viewpoint image of the viewpoint in the inversion region corresponding to the left eye of the viewer by a viewpoint image of other viewpoint in the same viewing zone farther away from the viewpoint corresponding to the right eye of the viewer, or replace the viewpoint image of the viewpoint in the inversion region corresponding to the right eye of the viewer by a viewpoint image of other viewpoint in the same viewing zone farther away from the viewpoint corresponding to the left eye of the viewer.

Two kinds of replacing methods are described below for the purpose of illustration.

First replacing method is that: the viewpoint in the inversion region corresponding to the left eye of the viewer or the viewpoint in the inversion region corresponding to the right eye of the viewer is spaced from the other viewpoint with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer.

For example, the replacing unit 123 is configured to replace the viewpoint image of the viewpoint in the inversion region corresponding to the left eye of the viewer by a viewpoint image of other viewpoint in the same viewing zone farther away from the viewpoint corresponding to the right eye of the viewer. If the viewpoint corresponding to the left eye is an edge viewpoint of the inversion region, then M=0, the viewpoint image of the viewpoint in the inversion region corresponding to the left eye of the viewer is replaced by a viewpoint image of other viewpoint spaced therefrom with a viewpoints; if the number of viewpoint between the viewpoint corresponding to the left eye and the edge viewpoint of the inversion region is 1, then M=1, the viewpoint image of the viewpoint in the inversion region corresponding to the left eye of the viewer is replaced by a viewpoint image of other viewpoint spaced therefrom with 2a viewpoints; and so on.

It is understood that, the serial number of the other viewpoint of replacing is smaller than that of the viewpoint corresponding to the left eye.

In order to further understand the embodiment, the number of viewpoints in each viewing zone being 28 and the number of viewpoint between the viewpoints respectively corresponding to the left eye and right eye being 6 will be taken as example below for description.

Since the viewpoints respectively corresponding to the left eye and right eye are across 6 viewpoints, and then a is equal to 3.

Regarding the left eye, the edge viewpoint of the inversion region is the viewpoint 23. When the viewpoint corresponding to the left eye is the viewpoint 23, then M is 0, and (M+1)×a=3, the viewpoint image of the viewpoint 23 in the inversion region corresponding to the left eye of the viewer is replaced by a viewpoint image of the viewpoint 20 which is spaced from the viewpoint 23 with 3 viewpoints and has a serial number of 20 smaller than that of the viewpoint 23; when the viewpoint corresponding to the left eye is the viewpoint 24, then M is 1, and (M+1)×a=6, the viewpoint image of the viewpoint 24 in the inversion region corresponding to the left eye of the viewer is replaced by a viewpoint image of the viewpoint 18 which is spaced from the viewpoint 24 with 6 viewpoints and has a serial number of 18 smaller than that of the viewpoint 24; when the viewpoint corresponding to the left eye is the viewpoint 25, then M is 2, and (M+1)×a=9, the viewpoint image of the viewpoint 25 in the inversion region corresponding to the left eye of the viewer is replaced by a viewpoint image of the viewpoint 16 which is spaced from the viewpoint 25 with 9 viewpoints and has a serial number of 16 smaller than that of the viewpoint 25; and so on, until viewpoint images of viewpoints in the inversion corresponding to the left eye each are replaced by a viewpoint image of a corresponding viewpoint spaced therefrom with [(M+1)×a] viewpoints.

By the above method, the viewpoint image having a large reversal degree with respect to the viewpoint image of the viewpoint corresponding to the right eye can be replaced to be a viewpoint image having a smaller reversal degree with respect to the viewpoint image of the viewpoint corresponding to the right eye, for example, when the viewpoint corresponding to the left eye is the viewpoint 23 and the viewpoint corresponding to the right eye is the viewpoint 1 in the neighboring viewing zone, before being replaced, a reversal degree of the two viewpoint images is (23−1)=22, and after being replaced, the reversal degree is changed to be (20−1)=19. Likewise, when the viewpoint corresponding to the left eye is the viewpoint 24 and the viewpoint corresponding to the right eye is the viewpoint 2 in the neighboring viewing zone, before being replaced, a reversal degree between the two viewpoint images is (24−2)=22, and after being replaced, the reversal degree is changed to be (18−1)=17. Accordingly, the reversal degree between the viewpoint image of the viewpoint in the inversion region corresponding to the left eye and the viewpoint image of the viewpoint in the inversion region corresponding to the right eye is reduced, and thus the degree of comfort to the viewer is improved.

It is understood that, after the viewpoint image of the viewpoint in the inversion region corresponding to the left eye is replaced to be a viewpoint image of other viewpoint according to the above method, the viewpoint image of the replaced viewpoint is used as the viewpoint image of the viewpoint corresponding to the right eye, a reversal of viewpoint image also may occurs.

Referring to the foregoing example of the number of viewpoint in each viewing zone being 28, in the situation of the viewpoint image of the viewpoint 25 corresponding to the left eye being replaced to be a viewpoint image of the viewpoint 16, when the viewpoint corresponding to the left eye is the viewpoint 19 and the viewpoint corresponding to the right eye is the viewpoint 25, the viewpoint image corresponding to the right eye actually is the viewpoint image of the viewpoint 16 of replacing, and thus the viewpoint image of the viewpoint 19 corresponding to the left eye and the viewpoint image of the viewpoint 16 corresponding to the right eye have a reversal with a reversal degree of 3.

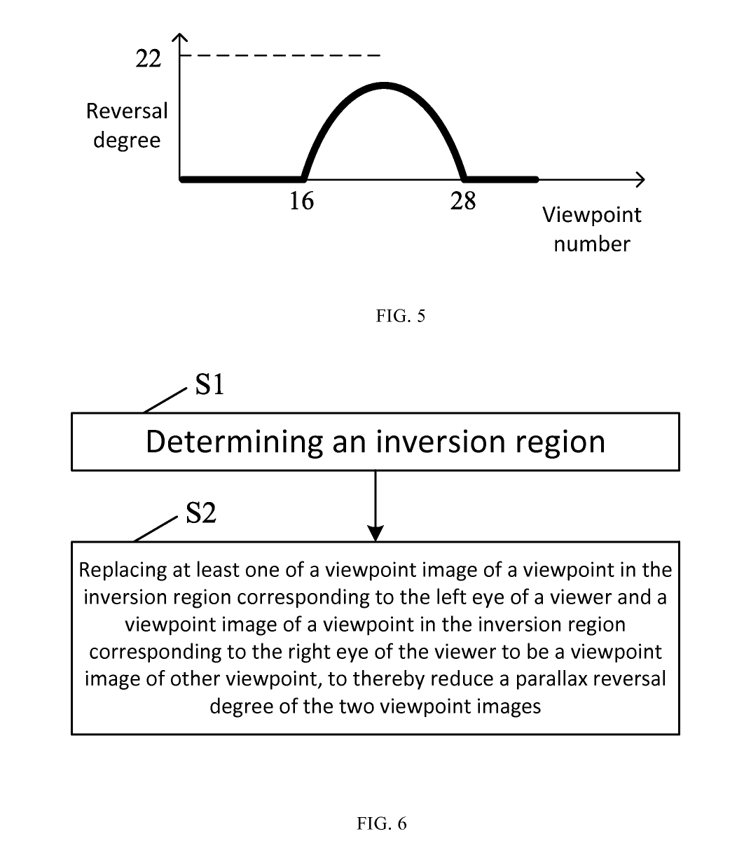

Accordingly, the first replacing method of the present invention converts viewpoint images of viewpoints with a high reversal degree into two viewpoint images with a lower reversal degree, and thereby the degree of comfort to the viewer is improved. Referring to FIGS. 4 and 5, FIG. 4 is a schematic view of viewpoint reversal before viewpoint(s) being replaced, and FIG. 5 is a schematic view of viewpoint reversal after viewpoint(s) being replaced.

It is understood that, if the replacing unit 123 is configured to replace the viewpoint image of the viewpoint in the inversion region corresponding to the right eye of the viewer to be a viewpoint image of other viewpoint in the same viewing zone farther away from the viewpoint corresponding to the left eye of the viewer, the principle is similar to that as described in the foregoing, and thus will not be repeated herein.

The above description is the first replacing method, and the second replacing method will be described below.

Second replacing method is that: a viewpoint in the inversion region corresponding to the left eye of the viewer or a viewpoint in the inversion region corresponding to the right eye of the viewer is spaced from other viewpoint of replacing with (a+M×b) viewpoints, where M is number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer, and b is a positive integer no greater than

$$\frac{N - a}{K - 1} .$$

For example, the replacing unit 123 is configured to replace the viewpoint image of the viewpoint in the inversion region corresponding to the left eye of the viewer to be a viewpoint image of other viewpoint in the same viewing zone farther away from the viewpoint corresponding to the right eye of the viewer. If the viewpoint corresponding to the left eye is an edge viewpoint of the inversion region, then M=0, and the viewpoint image of the viewpoint in the inversion region corresponding to the left eye of the viewer is replaced to be a viewpoint image of other viewpoint spaced therefrom with a viewpoints; if the number of viewpoint of the viewpoint corresponding to the left eye spaced from the edge viewpoint of the inversion region is 1, then M=1, and the viewpoint image of the viewpoint in the inversion region corresponding to the left eye of the viewer is replaced to be a viewpoint image of other viewpoint spaced therefrom with (a+b) viewpoints; and so on.

It is understood that, the serial number of the other viewpoint for replacing is smaller than that of the viewpoint corresponding to the left eye.

In order to further understand the embodiment, the number of viewpoint in each viewing zone being 28 and the number of viewpoint between the viewpoints respectively corresponding to the left eye and right eye being 6 will be taken as example below for description.

Since the viewpoints respectively corresponding to the left eye and right eye are across 6 viewpoints, and then a is equal to 3. A value of b is not greater than [(28−3)/(6−1)]=5, and in the embodiment b for example is set to be 4.

Regarding the left eye, the edge viewpoint in the inversion region is the viewpoint 23. When the viewpoint corresponding to the left eye is the viewpoint 23, then M is 0, and (a+M×b)=3, the viewpoint image of the viewpoint 23 in the inversion region corresponding to the left eye of the viewer is replaced to be a viewpoint image of the viewpoint 20 which is spaced from the viewpoint 23 with 3 viewpoints and has a serial number of 20 smaller than that of the viewpoint 23; when the viewpoint corresponding to the left eye is the viewpoint 24, then M is 1, and (a+M×b)=7, the viewpoint image of the viewpoint 24 in the inversion region corresponding to the left eye of the viewer is replaced to be a viewpoint image of the viewpoint 17 which is spaced from the viewpoint 24 with 7 viewpoints and has a serial number of 17 smaller than that of the viewpoint 24; and so on, until viewpoint images of viewpoints in the inversion corresponding to the left eye each are replaced to be a viewpoint image of a corresponding viewpoint spaced therefrom with (a+M×b) viewpoints.

Accordingly, the second replacing method of the present invention also converts viewpoint images of viewpoints with a high reversal degree into two viewpoint images with a lower reversal degree, and thereby the degree of comfort to the viewer is improved. The viewpoint reversal before viewpoint(s) being replaced and the viewpoint reversal after viewpoint(s) being replaced are the same as the illustrations of FIGS. 4 and 5.

Likewise, if the replacing unit 123 is configured to replace the viewpoint image of the viewpoint in the inversion region corresponding to the right eye of the viewer to be a viewpoint image of other viewpoint in the same viewing zone farther away from the viewpoint corresponding to the left eye of the viewer, the principle is similar to that as described in the foregoing, and thus will not be repeated herein.

In another aspect, an exemplary embodiment of the present invention also provide an image displaying method for a multi-view stereoscopic display device based on the foregoing image displaying apparatus for a multi-view stereoscopic display device. For details, please refer to FIG. 6.

As shown in FIG. 6, the image displaying method for a multi-view stereoscopic display device includes the following steps S1 and S2.

Step S1: determining an inversion region.

The inversion region is a location where a viewpoint corresponding to left eye of the viewer and another viewpoint corresponding to right eye of the viewer respectively are in neighboring viewing zones.

Step S2: replacing at least one of a viewpoint image of the viewpoint in the inversion region corresponding to the left eye of the viewer and another viewpoint image of the viewpoint in the inversion region corresponding to the right eye of the viewer to be a viewpoint image of other viewpoint, to thereby reduce a parallax reversal degree between the two viewpoint images of the left and right eyes.

In an exemplary embodiment, the step S2 specifically includes: obtaining a location of a viewer, judging the location of the viewer whether is in the inversion region, and when the location is judged to be in the inversion region, replacing at least of the viewpoint image of the viewpoint in the inversion region corresponding to the left eye of the viewer and the viewpoint image of the viewpoint in the inversion region corresponding to the right eye of the viewer to be a viewpoint image of other viewpoint.

In other embodiment, the steps of obtaining the location of a viewer and judging the location of the viewer whether is in the inversion region can be omitted. In particular, in the manufacturing of the multi-view stereoscopic display device 10, determining the inversion region and a normal region directly according to a distribution of viewpoints of viewing zone, and then directly performing a replacing operation applied to the viewpoint image(s) of the viewpoint(s) in the inversion region.

In the step S2, the viewpoint image of the viewpoint in the inversion region corresponding to the left eye of the viewer is replaced to be a viewpoint image of other viewpoint in the same viewing zone farther away from the viewpoint corresponding to the right eye of the viewer, or the viewpoint image of the viewpoint in the inversion region corresponding to the right eye of the viewer is replaced to be a viewpoint image of other viewpoint in the same viewing zone farther away from the viewpoint corresponding to the left eye of the viewer.

More specifically, there are two method of replacing, the first replacing method is that:

The viewpoint in the inversion region corresponding to the left eye of the viewer or the viewpoint in the inversion region corresponding to the right eye of the viewer is spaced from the other viewpoint for replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, and K is a number of viewpoint in an interval between the left eye and right eye of the viewer.

Concrete implementation of the first replacing method is as described above, and thus will not be repeated herein.

The second replacing method is that:

The viewpoint in the inversion region corresponding to the left eye of the viewer or the viewpoint in the inversion region corresponding to the right eye of the viewer is spaced from the other viewpoint for replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,

$$a = int ( \frac{N - K}{K} ) ,$$

N is a number of viewpoint in the viewing zone, K is a number of viewpoint in an interval between the left eye and right eye of the viewer, and b is a positive integer no greater than

$$\frac{N - a}{K - 1} .$$

Concrete implementation of the second replacing method is as described above, and thus will not be repeated herein.

In summary, the present invention replaces at least one of the viewpoint image of the viewpoint in the inversion region corresponding to the left eye of the viewer and the viewpoint image of the viewpoint in the inversion region corresponding to the right eye of the viewer to be a viewpoint image of other viewpoint to thereby reduce the parallax reversal degree of the two viewpoint images, so that the content difference between the viewpoint images of the viewpoints respectively corresponding to the left eye and right eye is reduced, and the degree of comfort of viewing to the viewer is improved consequently.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image displaying method for a multi-view stereoscopic display device, the multi-view stereoscopic display device having a plurality of viewing zones periodically arranged along a horizontal direction, each of the plurality of viewing zones comprising a plurality of viewpoints, and viewpoint images of neighboring viewpoints in each of the plurality of viewing zones having a predetermined parallax therebetween; the image displaying method comprising:
determining an inversion region;
obtaining a location of a viewer;
judging the location of the viewer whether is in the inversion region, and when the location of the viewer is in the inversion region, replacing a viewpoint image of a viewpoint in the inversion region corresponding to left eye of the viewer to be a viewpoint image of other viewpoint in a same viewing zone farther away from a viewpoint corresponding to right eye of the viewer, or replacing a viewpoint image of the viewpoint in the inversion region corresponding to the right eye of the viewer to be a viewpoint image of other viewpoint in a same viewing zone farther away from the viewpoint corresponding to the left eye of the viewer, to thereby reduce a parallax reversal degree of the viewpoint images.

2. The image displaying method as claimed in claim 1, wherein the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, and K is a number of viewpoint between the left eye and the right eye of the viewer.

3. The image displaying method as claimed in claim 1, wherein the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, K is a number of viewpoint between the left eye and the right eye of the viewer, and b is a positive integer no greater than
$$\frac{N - a}{K - 1} .$$

4. An image displaying method for a multi-view stereoscopic display device, the multi-view stereoscopic display device having a plurality of viewing zones periodically arranged along a horizontal direction, each of the plurality of viewing zones comprising a plurality of viewpoints, and viewpoint images of neighboring viewpoints in each of the plurality of viewing zones having a predetermined parallax therebetween; the image displaying method comprising:
determining an inversion region, wherein the inversion region is a location where a viewpoint corresponding to left eye of a viewer and a viewpoint corresponding to right eye of the viewer respectively are in neighboring ones of the plurality of viewing zones; and
replacing at least one of a viewpoint image of the viewpoint in the inversion region corresponding to the left eye of the viewer and a viewpoint image of the viewpoint in the inversion region corresponding to the right eye of the viewer to be a viewpoint image of other viewpoint, to thereby reduce a parallax reversal degree of the viewpoint images.

5. The image displaying method as claimed in claim 4, wherein before the step of replacing, further comprises:
obtaining a location of the viewer;
judging the location of the viewer whether is in the inversion region, and when the location of the viewer is judged to be in the inversion region, performing the step of replacing.

6. The image displaying method as claimed in claim 4, wherein the step of replacing comprises:
replacing the viewpoint image of the viewpoint in the inversion region corresponding to the left eye of the viewer to be a viewpoint image of other viewpoint in a same viewing zone farther away from the viewpoint corresponding to the right eye of the viewer, or
replacing the viewpoint image of the viewpoint in the inversion region corresponding to the right eye of the viewer to be a viewpoint image of other viewpoint in a same viewing zone farther away from the viewpoint corresponding to the left eye of the viewer.

7. The image displaying method as claimed in claim 6, wherein the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, and K is a number of viewpoint between the left eye and right eye of the viewer.

8. The image displaying method as claimed in claim 6, wherein the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, K is a number of viewpoint between the left eye and right eye of the viewer, and b is a positive integer no greater than
$$\frac{N - a}{K - 1} .$$

9. An image displaying apparatus for a multi-view stereoscopic display device, the multi-view stereoscopic display device having a plurality of viewing zones periodically arranged along a horizontal direction, each of the plurality of viewing zones comprising a plurality of viewpoints, and viewpoint images of neighboring viewpoints in each of the plurality of viewing zones having a predetermined parallax therebetween; the image displaying apparatus comprising:
a determining module, configured to determine an inversion region, wherein the inversion region is a location where a viewpoint corresponding to left eye of a viewer and a viewpoint corresponding to right eye of the viewer respectively are in neighboring ones of the plurality of viewing zones; and
a processing module, configured to replace at least one of a viewpoint image of the viewpoint in the inversion region corresponding to the left eye of the viewer and a viewpoint image of the viewpoint in the inversion region corresponding to the right eye of the viewer to be a viewpoint image of other viewpoint, to thereby reduce a reversal degree of the viewpoint images.

10. The image displaying apparatus as claimed in claim 9, wherein the processing module comprises:
an obtaining unit, configured to obtain a location of the viewer;
a judging unit, configured to judge the location of the viewer whether is in the inversion region; and
a replacing unit, configured to replace at least one of the viewpoint image of the viewpoint in the inversion region corresponding to the left eye of the viewer and the viewpoint image of the viewpoint in the inversion region corresponding to the right eye of the viewer to be the viewpoint image of the other viewpoint when the judging unit judges that the location of the viewer is in the inversion region.

11. The image displaying apparatus as claimed in claim 9, wherein the replacing unit is configured to replace the viewpoint image of the viewpoint in the inversion region corresponding to the left eye of the viewer to be a viewpoint image of other viewpoint in a same viewing zone farther away from the viewpoint corresponding to the right eye of the viewer, or replace the viewpoint image of the viewpoint in the inversion region corresponding to the right eye of the viewer to be a viewpoint image of other viewpoint in a same viewing zone farther away from the viewpoint corresponding to the left eye of the viewer.

12. The image displaying apparatus as claimed in claim 11, wherein the viewpoint in the inversion region corresponding to the left eye of the viewer or the viewpoint in the inversion region corresponding to the right eye of the viewer is spaced from the other viewpoint of replacing with [(M+1)×a] viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, and K is a number of viewpoint between the left eye and right eye of the viewer.

13. The image displaying apparatus as claimed in claim 11, wherein the viewpoint in the inversion region corresponding to the left eye of the viewer or the viewpoint in the inversion region corresponding to the right eye of the viewer is spaced from the other viewpoint of replacing with (a+M×b) viewpoints, where M is a number of viewpoint of the viewpoint in the inversion region corresponding to the left eye of the viewer or the viewpoint in the inversion region corresponding to the right eye of the viewer spaced from an edge viewpoint of the inversion region,
$$a = int ( \frac{N - K}{K} ) ,$$
N is a number of viewpoint in the viewing zone, K is a number of viewpoint between the left eye and right eye of the viewer, and b is a positive integer no greater than
$$\frac{N - a}{K - 1} .$$
